(19) United States
(12) Patent Application Publication
(10) Pub. No.: US 2016/0201627 A1
(43) Pub. Date: Jul. 14, 2016

(54) Gas Fuel System Sizing for Dual Fuel Engines

(71) Applicant: Caterpillar Inc., Peoria, IL (US)

(72) Inventors: Michael Gough, Lafayette, IN (US); Ryan Snodgrass, Fowler, IN (US); Nathan Atterberry, Washington, IL (US)

(73) Assignee: Caterpillar Inc., Peoria, IL (US)

(21) Appl. No.: 14/593,472

(22) Filed: Jan. 9, 2015

(51) Int. Cl. F02M 43/04

(52) U.S. Cl. CPC F02M 43/04

(57) ABSTRACT

The disclosure relates to a system and method for sizing of system components in a dual fuel port injection system. The system includes a pressure regulator and a safety shut-off valve that feeds a main gas rail. The gas rail is operatively connected to a gas admission valve by a gas jumper tube. The gas admission valve is operatively connected to a gas admission port in a cylinder head or to an intake runner via a gas delivery tube. The gas admission valve has an effective cross sectional area that is defined by the actual cross sectional area multiplied by a modifying coefficient. The components of the system are sized based upon the effective cross sectional area of the gas admission valve.

### TECHNICAL FIELD

This disclosure relates generally to internal combustion engines, and more particularly, to a system and method to properly size a port injection system to deliver a proper amount of fuel to a dual fuel engine.

### BACKGROUND

The proper sizing of port injection systems used in dual fuel engines is important in order for an engine to function efficiently. Port injection systems combine and mix fuel and air in an intake port prior to the mixture entering an engine cylinder. An admission valve or injector may be used to inject the fuel into the port where the fuel and air can mix. When a cylinder intake valve opens, the fuel/air mixture is pulled into the cylinder for a combustion process. If an improper amount of fuel is injected, this may lead to gas supply pressure variations in a gas admission valve or other problems, which may affect the performance of the engine.

Current systems for regulating gas supply pressure include the use of pressure regulating units. U.S. Patent Publication No. 2012/0199192 A1 (hereinafter “the '192 publication”) discloses a gas fuel admission system for a gas fired engine. The gas admission system includes a gas pressure regulating unit, a gas admission valve, and a gas pressure relief device. The gas pressure regulating unit is configured to discharge gas into a supply gas conduit at an injection pressure and the gas admission valve is configured to admit the pressurized gas from the supply conduit into an engine. The gas pressure relief device can relieve overpressure of the gas in the gas supply conduit if there is a pressure differential between the injection gas pressure and an intake air pressure. Although these current systems may provide an approach to correct the gas injection pressure, they can create inefficiencies in the gas admission, process by relieving pressurized gas, and they require additional components to sense and relieve overpressure.

Thus, an improved port injection system for dual fuel engines having properly sized components is desired to increase efficiencies, ensure that the appropriate amount of fuel is injected into a cylinder per injection event, and ensure that the system is functioning properly.

### SUMMARY

An aspect of the present disclosure provides a gas admission assembly having a gas admission valve and a gas jumper tube. The gas admission valve includes a valve inlet and a valve outlet. The gas admission valve defines a valve channel that connects the valve inlet and the valve outlet. The valve channel includes an actual valve cross sectional area, an effective valve cross sectional area, and an effective valve diameter. The effective valve cross sectional area is the actual valve cross sectional area multiplied by a modifying coefficient. The effective valve diameter is the diametral equivalence of the effective valve cross sectional area. The gas jumper tube includes a gas jumper inlet and a gas jumper outlet. The gas jumper tube defines a first channel that includes a first cross sectional area and a first length. The first channel connects the gas jumper inlet and the gas jumper outlet. The gas jumper outlet is fluidly coupled to the valve inlet. The first cross sectional area ranges from two times to eight times the effective valve cross sectional area of the gas admission valve, and the first length is at least ten times the length of the effective valve diameter of the gas admission valve.

Another aspect of the present disclosure provides a method for assembling a gas admission assembly. The method includes aligning a gas jumper tube with a gas admission valve and connecting the gas jumper tube to the gas admission valve. The gas admission valve includes a valve inlet and a valve outlet, and defines a valve channel connecting the valve inlet and the valve outlet. The valve channel has an actual valve cross sectional area, an effective valve cross sectional area, and an effective valve diameter. The effective valve cross sectional area is the actual valve cross sectional area multiplied by a modifying coefficient, and the effective valve diameter is the diametral equivalence of the effective valve cross sectional area. The gas jumper tube includes a gas jumper inlet and a gas jumper outlet, and defines a first channel having a first cross sectional area and a first length. The first channel connects the gas jumper inlet and the gas jumper outlet, and the gas jumper outlet is fluidly coupled to the valve inlet. The first cross sectional area ranges from two times to eight times the effective valve cross sectional area, and the first length is at least ten times the length of the effective valve diameter.

Another aspect of the present disclosure provides a fuel injection system having a gas rail for providing fuel to a cylinder and a gas admission valve. The gas rail defines a gas jumper tube and a gas admission valve housing. The gas jumper tube includes a gas jumper inlet and a gas jumper outlet, and defines a first channel having a first cross sectional area and a first length. The first channel connects the gas jumper inlet and the gas jumper outlet. The gas admission valve is positioned within the gas admission valve housing. The gas admission valve includes a valve inlet and a valve outlet, and defines a valve channel that connects the valve inlet and the valve outlet. The valve channel includes an actual valve cross sectional area, an effective valve cross sectional area, and an effective valve diameter. The effective valve cross sectional area is the actual valve cross sectional area multiplied by a modifying coefficient, and the effective valve diameter is the diametral equivalence of the effective valve cross sectional area. The gas jumper outlet is fluidly coupled to the valve inlet. The first cross sectional area ranges from two times to eight times the effective valve cross sectional area, and the first length is at least ten times the length of the effective valve diameter.

### BRIEF DESCRIPTION OF THE DRAWINGS

FIG. 1 illustrates a schematic of a dual fuel system, according to an aspect of the disclosure.

FIG. 2 illustrates a cross-sectional perspective view of a portion of a gas admission assembly, according to an aspect of the disclosure.

FIG. 3 is a cross sectional view of a gas admission valve, according to an aspect of the disclosure.

FIG. 4 illustrates a cross-sectional side view of a portion of a gas admission assembly, according to an aspect of this disclosure.

FIG. 5 illustrates a perspective view of a gas rail section having multiple gas admission assemblies, according to an aspect of this disclosure.

### DETAILED DESCRIPTION OF ILLUSTRATIVE EMBODIMENTS

The disclosure relates generally to dual fuel port injection systems that have properly sized components. A dual fuel system may have two fuel supply lines, one supply line for each type of fuel. For example, a dual fuel system may run on diesel fuel and gasoline. Generally, the dual fuel system provides only one fuel at a time. A dual fuel port injection system may include a variety of components, including a gas admission valve and a gas rail, that form a fuel supply line that injects a fuel into an intake manifold or injection port of a cylinder. The gas admission valve may be used to control the flow of the fuel into the intake manifold. In an embodiment, the gas admission valve may be integrally mounted onto the gas rail. In order to ensure the proper amount of fuel is injected into the cylinder, each of the components that compose the port injection system may be selected based upon the dimensions of the gas admission valve.

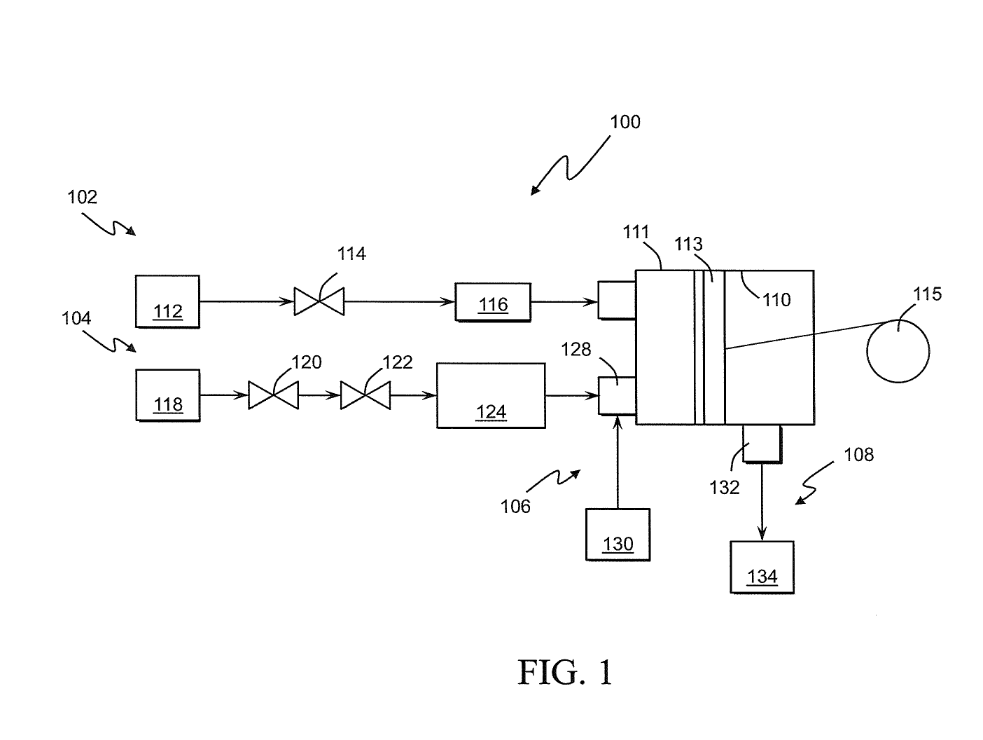

FIG. 1 illustrates a schematic of a dual fuel system 100, according to one aspect of the disclosure. In this view, the dual fuel system 100 is shown illustrating two fuel lines, including a diesel supply line 102 and a gas fuel supply line 104, an air intake line 106, and an exit exhaust line 108. Air and fuel flow through the system 100 into the cylinder 110. After entering the cylinder 110, the diesel fuel may self-ignite, which in turn, may ignite the fuel and move a piston 113. After the combustion process, the exhaust gases exit along the exit exhaust line 108.

The diesel supply line 102 may include various components known and used in the art including a diesel supply tank 112, fuel control valve 114, and a fuel pump 116. The diesel supply line 102 may include other components including filters, rack control valves, relief valves, or the like, none of which are shown for clarity. The fuel pump 116 is disposed along the diesel supply line 102 downstream of the diesel fuel supply 112. The fuel pump 116 may pump diesel fuel into the cylinder 110 of the fuel system 100. It should be appreciated that a rail type system (not shown), also referred to as a common rail, or a fuel manifold may be used to supply diesel fuel to the cylinder 110.

The gas supply line 104 may include a gas fuel supply 118, a fuel pressure regulator or valve 120, a shut-off valve 122, and a gas admission assembly 124. It should be appreciated that other fuel line components may be used in the gas supply line 104. The gas fuel supply 118 may include a liquefied fuel tank, a cryogenic pump, and other such elements as are commonly used and known in the art. The pressure regulator 120 may receive gas fuel from the gas fuel supply 118 prior to the fuel entering the gas admission assembly 124. The gas fuel enters the gas admission assembly 124 under pressure from the fuel supply 118 when the pressure regulator 120 is in an open position. The fuel is selectively controlled and timed before entering an intake manifold or gas admission port 128. The intake manifold 128 may be coupled to an engine housing 111 and configured to supply intake air as well as gas fuel to each cylinder 110.

The shut-off valve 122 may be configured to be fluidly connected to the gas supply line 104 connecting the pressure regulator 120 to the gas admission assembly 124. The shut-off valve 122 may be controlled by an operator or a controller. In an embodiment, when the dual fuel system 100 is an a diesel supply mode, whereby fuel is provided to the cylinder 110 via the diesel supply line 102, the valve 122 may be controlled to a close position restricting the flow of gas from the gas supply line 104 into the gas admission assembly 124. The shut-off valve may be controlled based on the fuel system 100 load, speed, and/or other fuel system parameters.

The air intake line 106 includes an air inlet 130 for supplying air to the intake manifold 128. Various components known and used in the art may form part of the air intake line 106 including a compressor, an aftercooler, filters, or the like. In other embodiments, the air intake line 106 may include one or more valves for various purposes including for controlling the intake pressure into the engine 100. The intake air is combined with the gas fuel within the intake manifold 128 and provided to the engine cylinder 110 for combustion.

After the diesel fuel and/or the air and gas fuel mixture flow through their corresponding supply lines, they enter the cylinder 110. It should be appreciated that there may be additional cylinders which are not shown in FIG. 1, commonly six, eight, twelve or more cylinders, each having a piston 113 reciprocable therein to contribute to the rotation of a crankshaft 115. During a combustion process, the diesel fuel may self-ignite, which in turn may ignite the gaseous fuel, thereby driving the piston 113 and inducing rotation of the crankshaft 115.

After the combustion process, the exhaust created during combustion flows out of the cylinder 110, along the exhaust line 108 from an exhaust manifold 132 to an exhaust outlet 134.

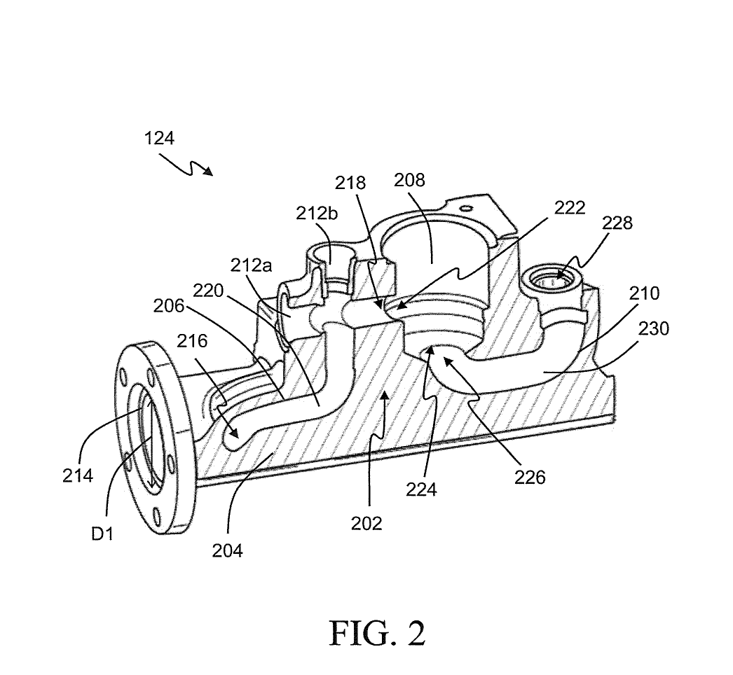

FIG. 2 illustrates a cross-sectional perspective view of a portion of the gas admission assembly 124. The gas admission assembly 124 includes a gas admission line 202 that composes a portion of the gaseous supply line 104. The gas admission assembly 124 further includes a portion of a gas rail 204, a gas jumper tube 206, a gas admission valve housing 208, a gas delivery tube 210, and gas line plug housings 212a and 212b.

The gas rail 204 may define a gas rail channel 214 that fluidly couples the pressure regulator 120 and the shut-off valve 122 to the gas admission line 202. The gas rail channel 214 may also fluidly couple the pressure regulator 120 and the shut-off valve 122 to multiple gas admission lines, that each provides gaseous fuel to a corresponding cylinder. The gas rail channel 214 may have a diameter D1 and a cross sectional area corresponding to the diameter D1.

The gas jumper tube 206 may have a gas jumper inlet 216 and a gas jumper outlet 218, and may define a jumper channel 220 connecting the gas jumper inlet 216 to the gas jumper outlet 218. The gas jumper inlet 216 may be fluidly coupled to the gas rail channel 214. The gas jumper tube 206 may be an independent component that is linear or curvilinear in shape and coupled to the gas rail 204. In an alternative embodiment, the jumper tube 206 may be formed or defined by the gas rail 204.

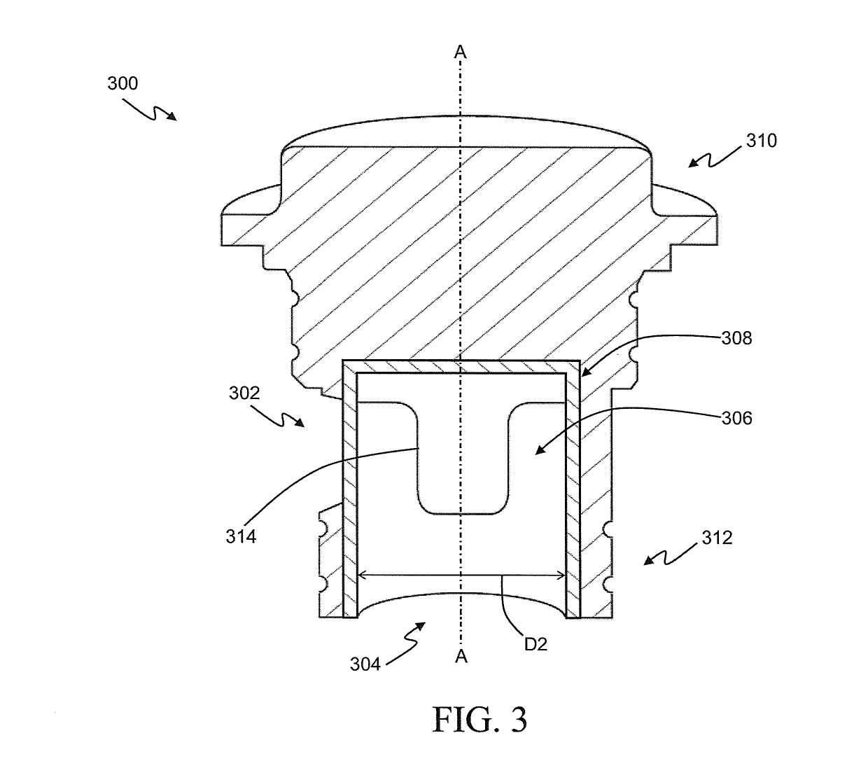

The gas admission valve housing 208 may be configured to support a gas admission valve 300 (FIG. 3) within. The housing 208 may be coupled to the gas rail 204 or may be formed or defined by the gas rail 204. The housing 208 may be positioned adjacent to the gas jumper tube 206 and may include a housing inlet 222 and a housing outlet 224. The housing inlet 222 may be aligned with the gas jumper outlet 218 such that the jumper channel 220 may be fluidly coupled to the gas admission valve housing 208.

The gas delivery tube 210 may include a gas delivery tube inlet 226 and a gas delivery tube outlet 228, and may define a delivery tube channel 230 connecting the delivery tube inlet 226 to the delivery tube outlet 228. The delivery tube inlet 226 may be fluidly coupled to the valve housing outlet 224. The delivery tube 210 may fluidly connect to the gas admission port 128. The delivery tube 210 may be an independent component that is coupled to the gas rail 204 or the delivery tube 210 may be formed or defined by the gas rail 204.

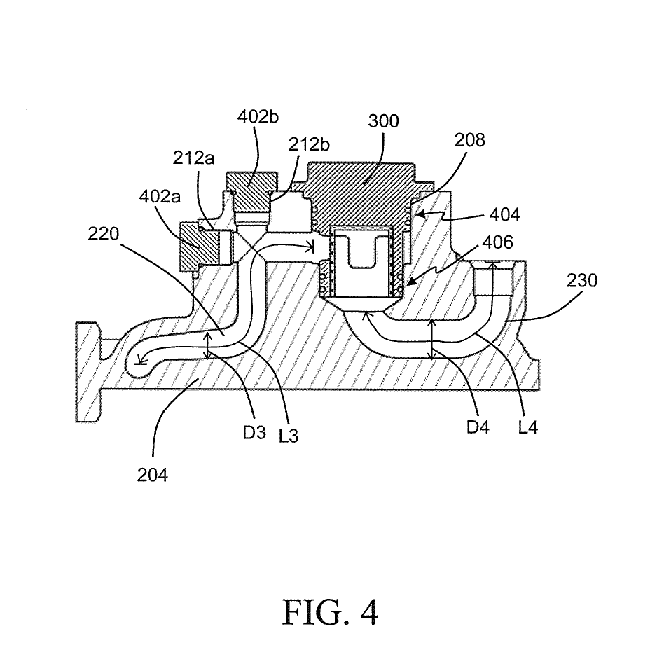

The gas line plug housings 212a and 212b may be positioned along the jumper tube channel 220. The gas line plug housings 212a and 212b may be configured to support gas line plugs 402a and 402b, respectively, which are shown and described in more detail in FIG. 4.

FIG. 3 illustrates a perspective view of a cross section of the gas admission valve 300, according to one aspect of this disclosure. The gas admission valve 300 includes a valve inlet 302 and a valve outlet 304. The gas admission valve 300 may define a valve channel 306 that connects the valve inlet 302 and the valve outlet 304. The valve 300 may be positioned within the valve housing 208, as shown in FIG. 4, such that the valve inlet 302 may be fluidly coupled to the jumper tube outlet 218 and the valve outlet 304 may be fluidly coupled to the delivery tube inlet 226, thereby providing a fluid connection between the gas jumper tube 206 and the gas delivery tube 210.

Returning to FIG. 3, the valve 300 may further include a rotatable portion 308 to control the flow of gas through the valve 300 and into the gas delivery tube 210. The rotatable portion 308 may rotate about a central longitudinal axis A-A. The central longitudinal axis A-A may extend from the center of an upper portion 310 of the valve 300 to the center of a lower portion 312 of the valve 300. The rotatable portion 308 defines an opening 314, such that a rotation of the rotatable portion 308 about the central longitudinal axis A-A may align and fluidly connect the opening 314 with the valve inlet 302. When the opening 314 is aligned with the valve inlet 302, the gas jumper tube 206 may be fluidly coupled to the valve 300. The rotatable portion 308 may further rotate about the longitudinal axis A-A so that the opening 314 is not in alignment with the valve inlet 302. When the opening 314 is not aligned with the valve inlet 302, the gas jumper tube 206 and the valve 300 are not fluidly coupled.

In an embodiment, fuel provided to the gas admission line 202 from the gas rail 204 may flow from the gas jumper tube 206 through the gas admission valve 300 and into the gas delivery tube 210. The gas may enter into the gas admission port 128 and mix with air from the air intake line 106 prior to entering into the cylinder 110. The gas admission valve 300 may be configured to control the admission of gas into the intake manifold 128 at a predetermined time and for a predetermined duration.

The valve channel 306 may have a cross sectional area having a diameter D2 that varies along a length (not labelled) of the channel 306. The diameter D2 may have different sizes at different points along the channel 306. The varying cross sectional area may be a result of different valve inlet 302 and valve outlet 304 sizes, a curvilinear or elliptical shape of the valve channel 306, or for other reasons. Therefore, since the actual cross sectional area may vary, an effective cross sectional area may be determined to provide an average or approximate cross sectional area for the valve channel 306. The effective cross sectional area may be approximated by multiplying the actual cross sectional area, or an average of the actual cross sectional area, by a discharge or modifying coefficient. A diametral equivalence may be calculated from the effective cross sectional area.

The discharge or modifying coefficient may contain multiple parameters including the length of the channel 306, the cross sectional area of the valve inlet 302 or valve outlet 304, or other similar parameters, or other parameters related to the gaseous fuel flowing through the valve 300, such as the flow rate, density, or volume, for example. The coefficient may be theoretically or empirically derived.

The size of each of the components of the gas admission assembly 124, including the gas rail 204, the gas jumper tube 206, and the gas delivery tube 210, may be selected based upon the effective cross sectional area and/or the diametral equivalence of the effective cross sectional area of the gas admission valve 300. Appropriately sized components may help ensure that the correct amount of fuel is delivered per injection event.

FIG. 4 illustrates a cross-sectional side view of a portion of the gas admission assembly 124 (see FIG. 2) having the gas admission valve 300 mounted within the housing 208, and the support gas line plugs 402a and 402b mounted within the gas line plug housings 212a and 212b, respectively. The valve 300 may be securely attached to the rail 204 by attachment means commonly used in the art. The valve 300 may also include sets of o-rings 404 and 406 to reduce the amount of fuel that may leak from the valve 300 during a fuel injection event.

FIG. 4 also illustrates the various dimensions of the jumper channel 220 and the delivery tube channel 230. The jumper channel 220 may have a cross sectional area corresponding to a jumper tube diameter D3, and a jumper tube length L3 that extends the length of the jumper channel 220. The jumper tube diameter D3 may have a consistent length throughout the length L3 of the jumper channel 220, however, it should be appreciated that the jumper tube diameter D3 may vary or be inconsistent throughout the length L3. When referring to the jumper diameter D3, it should be assumed that the diameter D3 is the actual diameter of the jumper channel 220 when the channel 220 has a constant diameter for the entire length L3, and that D3 is an average diameter of the jumper channel 220 when the channel 220 has an inconsistent diameter throughout the length L3 of the jumper channel 220. In an embodiment, the cross sectional area corresponding to the jumper tube diameter D3 may be two times to eight times the effective cross sectional area of the gas admission valve 300. Additionally, the length L3 of the jumper channel 220 may be at least ten times the length of the diametral equivalence of the effective cross sectional area of the gas admission valve 300.

The delivery tube channel 230 may have a cross sectional area corresponding to the delivery tube channel diameter D4, and a delivery tube length L4 that extends the length of the delivery tube channel 230. The delivery tube diameter D4 may have a consistent length throughout the length L4 of the delivery tube channel 230, however, it should be appreciated that the delivery tube diameter D4 may vary or be inconsistent throughout the length L4. When referring to the delivery tube diameter D4, it should be assumed that the diameter D4 is the actual diameter of the delivery tube channel 230 when the channel 230 has a constant diameter for the entire length L4, and that D4 is an average diameter of the delivery tube channel 230 when the channel 230 has an inconsistent diameter throughout the length L4 of the delivery tube channel 230. In an embodiment, the cross sectional area corresponding to the diameter D4 should be large enough not to create a restriction outside of the gas admission valve 300. The cross sectional area corresponding to diameter D4 may be in the range of four times to ten times the effective cross sectional area of the gas admission valve 300.

The cross sectional area of the gas rail 204 corresponding to the diameter D1 (FIG. 2) may be thirty to seventy five times the effective cross sectional area of the gas admission valve 300.

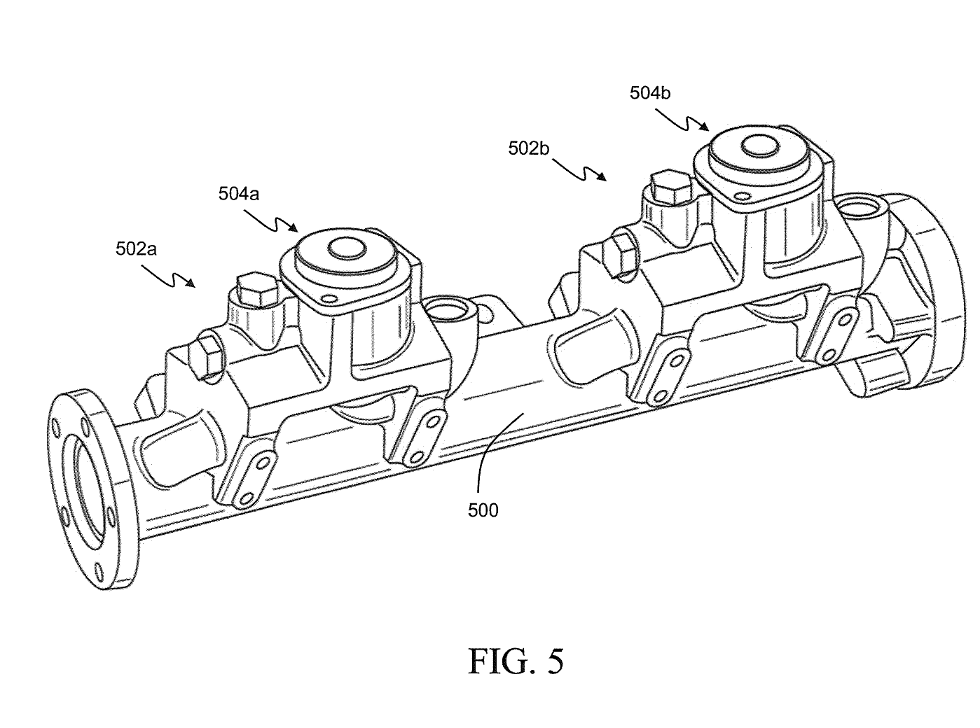

FIG. 5 illustrates a perspective view of an embodiment of a gas rail section 500 having multiple gas admission assemblies 502a and 502b, according to one aspect of this disclosure. Each gas admission assembly 502a and 502b may include a gas admission valve 504a and 504b mounted within, respectively, and have a configuration similar to gas admission assembly 124. The gas rail section 500 may include multiple sections connected in series and in parallel, composing a dual fuel system 100, to provide fuel to multiple engine cylinders. In an embodiment, each gas admission assembly 502a and 502b within the dual fuel system 100 may be sized according to aspects described herein.

### INDUSTRIAL APPLICABILITY

The present disclosure provides an advantageous system and method for properly sizing gas admission assembly 124 components. The gas admission assembly 124 may be used in dual fuel port injection engine systems 100. Port injection engines are well adapted for providing a wide range of fueling required from an idle condition to maximum power conditions, and may be used for applications such as powering heavy loaders, tractors, bulldozers, excavators, gensets, fracturing rigs, marine applications, or the like.

Properly sized gas admission assembly components, and an engine system 100 including a pressure regulator 120 and a safety shut-off valve 122, that feed a gas rail 204 can ensure that the correct amount of fuel is injected into an engine cylinder 110 per injection event. If an improper amount of fuel is injected, then gas supply pressure variations induced by the gas admission valve 300 may impact other cylinders connected to the same rail 204.

Additionally, significant vibration may occur during the fuel injection process of a dual fuel port injection engine which may cause gas admission valve 300 failures. Mounting the valve 300 within a rail housing 208, thereby integrating the valve 300 within the rail 204, can provide a more rigid support that can help minimize vibration related failures.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A gas admission assembly comprising:
a gas admission valve including:
a valve inlet;
a valve outlet; and
a valve channel connecting the valve inlet and the valve outlet, the valve channel including:
an actual valve cross sectional area;
an effective valve cross sectional area, wherein the effective valve cross sectional area is the actual valve cross sectional area multiplied by a modifying coefficient; and
an effective valve diameter, wherein the effective valve diameter is the diametral equivalence of the effective valve cross sectional area; and
a gas jumper tube including:
a gas jumper inlet;
a gas jumper outlet fluidly coupled to the valve inlet; and
a first channel connecting the gas jumper inlet and the gas jumper outlet, the first channel including:
a first cross sectional area, wherein the first cross sectional area ranges from two times to eight times the effective valve cross sectional area; and
a first length, wherein the first length is at least ten times the length of the effective valve diameter.

2. The gas admission assembly of claim 1, wherein the modifying coefficient may include parameters related to the valve cross sectional area, the valve inlet, and the valve outlet.

3. The gas admission assembly of claim 1, wherein the modifying coefficient is theoretically derived.

4. The gas admission assembly of claim 1, further comprising:
a gas delivery tube configured to accept fuel flowing through the gas admission valve, the gas delivery tube including:
a gas delivery inlet fluidly connected to the valve outlet;
a gas delivery outlet; and
a second channel connecting the gas delivery inlet and the gas delivery outlet, the second channel having a second cross sectional area.

5. The gas admission assembly of claim 3, wherein the second cross sectional area is four times to ten times the effective valve cross sectional area.

6. The gas admission assembly of claim 1, further comprising:
a gas rail fluidly coupled to the gas jumper inlet, the gas rail including:
a gas rail channel including:
a gas rail diameter, wherein the gas rail diameter ranges from thirty five times to seventy five times the effective valve diameter.

7. The gas admission assembly of claim 1, wherein the gas rail defines an admission valve housing positioned adjacent to the gas jumper tube, wherein the gas jumper outlet is fluidly coupled to the admission valve housing.

8. The gas admission assembly of claim 6, wherein the gas admission valve is positioned within the admission valve housing.

9. The gas admission assembly of claim 7, further comprising at least one o-ring positioned on an outer surface of the gas admission valve.

10. A method for assembling a gas admission assembly, comprising:
aligning a gas jumper tube with a gas admission valve, wherein the gas admission valve having a valve inlet and a valve outlet, and defining a valve channel connecting the valve inlet and the valve outlet, the valve channel having actual valve cross sectional area, an effective valve cross sectional area, and an effective valve diameter, wherein the effective valve cross sectional area is the actual valve cross sectional area multiplied by a modifying coefficient, and the effective valve diameter is the diametral equivalence of the effective valve cross sectional area, and wherein the gas jumper tube having a gas jumper inlet and a gas jumper outlet, and defining a first channel having a first cross sectional area and a first length, the first channel connecting the gas jumper inlet and the gas jumper outlet, wherein the gas jumper outlet is fluidly coupled to the valve inlet, and wherein the first cross sectional area ranges from two times to eight times the effective valve cross sectional area, and the first length is at least ten times the length of the effective valve diameter; and
connecting the gas jumper tube to the gas admission valve.

11. The method of claim 10, further comprising connecting a gas rail to the gas jumper tube, the gas rail defining a gas rail channel having a gas rail diameter, wherein the gas rail diameter ranges from thirty five times to seventy five times the effective valve diameter, wherein the gas rail is fluidly coupled to the gas jumper inlet.

12. The method of claim 10, further comprising connecting a gas delivery tube to the gas admission valve, the gas delivery tube having a gas delivery inlet and a gas delivery outlet, and defining a second channel connecting the gas delivery inlet and the gas delivery outlet, the second channel having a second cross sectional area, wherein the gas delivery inlet is fluidly connected to the valve outlet.

13. The method of claim 12, wherein the second cross sectional area is four times to ten times the effective valve cross sectional area.

14. The method of claim 11, further comprising connecting a pressure regulator to the gas rail, the pressure regulator configured to regulate a pressure of a fuel within the gas rail.

15. The method of claim 11, further comprising connecting a shut-off valve to the gas rail, the shut-off valve configured to restrict the flow of a fuel into the gas rail upon a failure.

16. A fuel injection system comprising:
a gas rail for providing fuel to a cylinder, the gas rail including:
a gas jumper tube including:
a gas jumper inlet;
a gas jumper outlet; and
a first channel connecting the gas jumper inlet and the gas jumper outlet, the first channel including:
a first cross sectional area; and
a first length; and
a gas admission valve housing; and
a gas admission valve positioned within the gas admission valve housing, the gas admission valve including:
a valve inlet;
a valve outlet; and
a valve channel connecting the valve inlet and the valve outlet, the valve channel including:
an actual valve cross sectional area;
an effective valve cross sectional area; and
an effective valve diameter, wherein the effective valve cross sectional area is the actual valve cross sectional area multiplied by a modifying coefficient, and wherein the effective valve diameter is the diametral equivalence of the effective valve cross sectional area,
wherein the gas jumper outlet is fluidly coupled to the valve inlet, and wherein the first cross sectional area ranges from two times to eight times the effective valve cross sectional area, and the first length is at least ten times the length of the effective valve diameter.

17. The fuel injection system of 16, wherein the fuel injection system is a dual fuel injection system.

18. The fuel injection system of claim 16, wherein the gas rail defines a gas delivery tube fluidly coupled to the valve outlet.

19. The fuel injection system of claim 16, wherein the gas rail defines a gas rail channel having a gas rail diameter, wherein the gas rail diameter ranges from thirty five times to seventy five times the effective valve diameter.

20. The fuel injection system of claim 16, further comprising:
a pressure regulator fluidly connected to the gas rail, and configured to regulate the pressure of a fuel within the gas rail; and
a safety shut-off valve fluidly coupled to the gas rail and positioned between the pressure regulator and the gas rail, and configured to relieve overpressure of gas within the gas rail.
